(19) United States
(12) Patent Application Publication
(10) Pub. No.: US 2025/0036710 A1
(43) Pub. Date: Jan. 30, 2025

(54) REGRESSION-BASED PLANT LIGHT ENVIRONMENT-CARBON SEQUESTRATION BENEFIT CURVE DETERMINATION METHOD AND SYSTEM, AND MEDIUM

(71) Applicant: Beijing Forestry University, Beijing (CN)

(72) Inventors: Fei Li, Beijing (CN); Zhandong Li, Beijing (CN); Xiaonan Yu, Beijing (CN); Weiru Yang, Beijing (CN)

(21) Appl. No.: 18/346,800

(22) Filed: Jul. 4, 2023

(51) Int. Cl. G06F 17/11; G06F 17/18

(52) U.S. Cl. CPC G06F 17/11; G06F 17/18

(57) ABSTRACT

The present disclosure belongs to the technical field of plant photoresponse and discloses a regression-based plant light environment-carbon sequestration benefit (a light response curve) determination method and system, and a medium. The method includes: performing data regression analysis by using various models; verifying data regression equations corresponding to the respective models; selecting a double hyperbolic curve regression model as an optimal one of the models; measuring red-blue light source by using a Li6400XT photosynthesis system; obtaining a light response curve through regression of the double hyperbolic curve; and obtaining corresponding formulas of light compensation (LCP) and a light saturation point (LSP) through regression. According to the present disclosure, a new double hyperbolic curve regression model is first adopted to fit the light response curve, so as to construct a more accurate photoresponse model.

### TECHNICAL FIELD

The present disclosure belongs to the technical field of plant photoresponse, and in particular relates to a regression-based plant light environment-carbon sequestration benefit curve (photoresponse curve) determination method and system, and a medium.

### BACKGROUND TECHNOLOGY

Currently, in a first related-art technique, a rectangular hyperbola model is used to perform regression analysis on photosynthetic data, and the following formula is obtained:

$$PHOTO = \frac{α \times P max}{α \times PAR + P max} \times PAR$$

in the formula, PHOTO is a net photosynthetic rate, PAR is photosynthetically active radiation, α is initial slope of a rapid light curve, and Pₘₐₓ is a maximum electron transfer efficiency.

In the first related-art technique, the rectangular hyperbola model is verified based on a mean squared error (RMSE) value as follows:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value when regression analysis is performed on data by using the rectangular hyperbola model is 0.70 for Prunus persica ‘Duplex’ that is a common garden plant in an area of Beijing (see Table 1), and the RMSE value when regression analysis is performed on data by using a new double hyperbolic curve in the present disclosure is 0.25. It is thus proved that the method of regression analysis by using the rectangular hyperbola model is deficient as compared with that using the double hyperbolic curve model. In other words, there is a big difference between the fitted value calculated by the regression fitting using the rectangular hyperbola model and the experimental value.

In a second related-art technique, a non-rectangular hyperbola (NRH) model is adopted to perform regression analysis on photosynthetic data as follows:

$$PHOTO = \frac{α \times PAR + P max - \sqrt{{( α \times PAR + P max )}^{2} - 4 θ \times PAR \times P max}}{2 θ}$$

in the formula, PHOTO is a net photosynthetic rate, PAR is a photosynthetically active radiation, α is an initial slope of a rapid light curve, Pₘₐₓ is a maximum electron transfer efficiency, and θ is a curvature of the rapid light curve.

In the second related-art technique, the non-rectangular hyperbola (NRH) model is verified based on the root mean squared error (RMSE) value as follows:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value when regression analysis is performed on data by using the non-rectangular hyperbola model is 0.43 for Prunus persica ‘Duplex’ that is a common garden plant in the area of Beijing (see Table 1), and the RMSE value in a case of the new double hyperbolic curve regression model in the present disclosure is 0.25. It is thus proved that the method of performing regression analysis by using the non-rectangular hyperbola (NHR) model is slightly deficient as compared with that using the new double hyperbolic curve regression model adopted in the present disclosure. There is a big difference between the fitted value calculated by the regression fitting formula of the non-rectangular hyperbola (NRH) model and the experimental value.

In a third related-art technique, an equation is constructed as follows by performing regression analysis on the data by using a single exponential equation:

PHOTO=Pmax×(1−e^{-α×PAR/Pmax})

in the formula, PHOTO is a net photosynthetic rate, PAR is a photosynthetically active radiation, α is an initial slope of the rapid light curve, Pₘₐₓ is a maximum electron transfer efficiency, and θ is a curvature of the rapid light curve.

In the third related-art technique, the equation, which is constructed by performing regression analysis on the data by using the single exponential equation, is verified based on the root mean squared error (RMSE) value as follows:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value when the data fitting regression analysis is performed by using the single exponential equation is 0.38 for Prunus persica ‘Duplex’ that is a common garden plant in the area of Beijing (see Table 1), and the RMSE value in a case of the new double hyperbolic curve regression model in the present disclosure is 0.25. It is thus proved that the method of performing regression analysis on data by using a single exponential regression model is slightly deficient as compared with that using the double hyperbolic curve model. There is a big difference between the fitted value calculated by using the single exponential regression method and the experimental value.

In a fourth related—are technique, a double exponential model (DEM) is adopted to perform regression analysis on data as follows:

PHOTO=Pmax×(1−e^{-α×PAR/Pmax})e^{-β/Pmax}

in the formula, PHOTO is a net photosynthetic rate, PAR is a photosynthetically active radiation, α is an initial slope of the rapid light curve, Pₘₐₓ is a maximum electron transfer efficiency, and β is an optical suppression parameter.

In the fourth related-art technique, the data regression equation of the double exponential model (DEM) is verified based on the root mean squared error (RMSE) value as follows:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value when the data regression equation of the double exponential model is used is 0.31 for Prunus persica ‘Duplex’ that is a common garden plant in the area of Beijing (see Table 1), and the RMSE value in a case of the new double hyperbolic curve in the present disclosure is 0.25. It is thus proved that the method of performing regression analysis on data by using the double exponential model is slightly deficient as compared with that using the double hyperbolic curve model. Therefore, the fitted value obtained by regression analysis by using the double exponential model is not close to the experimental value.

A modified rectangular hyperbolic (MRH) model is used in a fifth related-art technique to perform regression analysis on data as follows:

$$PHOTO = α \times \frac{1 - bPAR}{1 + cPAR}$$

in the formula, PHOTO is a net photosynthetic rate, PAR is a photosynthetically active radiation, α is an initial slope of the rapid light curve, and b and c are coefficients.

In the fifth related-art technique, the data regression equation of the modified rectangular hyperbolic (MRH) model is verified based on the root mean squared error (RMSE) value as follows:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value in a case of the modified rectangular hyperbolic model is 0.39 for Prunus persica ‘Duplex’ that is a common garden plant in the area of Beijing (see Table 1), and the RMSE value in a case of the double hyperbolic curve in the present disclosure is 0.25. It is thus proved that the method of regression using the modified rectangular hyperbolic model is not better than the method of regression analysis using the double hyperbolic curve model in the present disclosure. Therefore, the fitted value obtained by the modified rectangular hyperbolic model regression is least close to the experimental value.

The regression analysis is performed by using the above five equations, results are compared, and it is found that all values are greater than the value calculated by using a fitting equation of the double hyperbolic curve. Therefore, a new regression-based plant light environment-carbon sequestration benefit curve (light response curve) determination method is required.

Based on the above analysis, problems and deficiencies exist in the related-art techniques are as follows: there is a large difference between each of the fitted values respectively obtained by regression fitting using the rectangular hyperbola (RH) model, the non-rectangular hyperbola (NRH) model, the single exponential regression method (SEM), the double exponential model (DEM) and the modified rectangular hyperbolic (MRH) model and the experimental value, all the fitted values are greater than the value calculated by using the double hyperbolic curve fitting formula (NLS) (see Table 1) and are not close enough to the experimental value, causing a larger error of the fitted value of the photosynthetic carbon sequestration benefits calculated by using those regression models. The double hyperbolic curve fitting formula adopted in the present disclosure has better fitting accuracy as compared with the six models including the rectangular hyperbola model, non-rectangular hyperbola model, single exponential regression model, double exponential model and modified rectangular hyperbolic model (see Table 1).

TABLE 1
Comparison of RMSE values calculated by six regression
equations for common garden plants in area of Beijing

| | Double | | | | | |
|---|---|---|---|---|---|---|
| | hyperbolic | | | Single | | Modified |
| | curve | | | exponential | Double | rectangular |
| | fitting | Rectangular | Non-rectangular | regression | exponential | hyperbolic |
| | model | hyperbola | hyperbola | model | model | model |
| Name | (NLS) | (RH) model | (NRH) model | (SEM) | (DEM) | (MRH) |
| Lonicera | 0.38 | 0.80 | 0.57 | 0.60 | 0.48 | 0.48 |
| maackii | | | | | | |
| Prunus | 0.77 | 1.21 | 1.13 | 1.26 | 1.08 | 0.90 |
| davidiana | | | | | | |
| Syringa oblata | 0.39 | 0.71 | 0.58 | 0.64 | 0.51 | 0.49 |
| Lindl. | | | | | | |
| Acer truncatum | 0.36 | 1.00 | 0.85 | 0.77 | 0.71 | 0.60 |
| Bunge | | | | | | |
| Prunus persica | 0.25 | 0.70 | 0.43 | 0.38 | 0.31 | 0.39 |
| ‘Duplex’ | | | | | | |
| Ulmus pumila | 0.61 | 1.10 | 0.76 | 0.81 | 0.66 | 0.71 |
| L. | | | | | | |
| Tilia tuan | 0.55 | 1.08 | 0.97 | 0.95 | 0.93 | 0.59 |
| Szyszyl. | | | | | | |
| Sorbaria | 0.28 | 0.37 | 0.31 | 0.40 | 0.32 | 0.31 |
| sorbifolia | | | | | | |
| Syringa | 0.69 | 1.31 | 1.08 | 1.08 | 1.02 | 0.71 |
| reticulata | | | | | | |
| Koelreuteria | 0.18 | 0.46 | 0.36 | 0.35 | 0.28 | 0.31 |
| paniculata | | | | | | |
| Laxm. | | | | | | |
| Prunus sibirica | 0.57 | 0.91 | 0.77 | 0.83 | 0.72 | 0.64 |
| L. | | | | | | |
| Styphnolobium | 0.31 | 0.47 | 0.42 | 0.53 | 0.42 | 0.35 |
| japonicum | | | | | | |
| Platanus | 0.24 | 0.70 | 0.47 | 0.49 | 0.41 | 0.33 |
| occidentalis L. | | | | | | |

The difficulties of solving the above problems and deficiencies are mainly in that, at present, regarding description of plant photosynthetic properties, measurement relies on instruments almost 90% or higher of which are the LI6400XT and higher versions of photosynthesis instruments, the above-mentioned five regression model formulas having high maturity and wide application are used as some of regression equations for data analysis provided by companies from America and experimental data of red-blue light source measured by the LI6400XT instrument is directly substituted into the regression equation and published in periodicals. Therefore, it is difficult to explore a method that is more accurate than all existing methods. According to the present disclosure, photosynthetic data of the red-blue light source is measured for nearly 90 garden tree species in the area of Beijing in field environment, regression analysis is performed on the data by using the above five regression models and the double hyperbolic curve model proposed in the present disclosure, results are compared, and it shows that the latter is applicable to the photosynthetic data of the red-blue light source in the field environment and is a more accurate fitting regression method than the above commonly used five regression models.

Solving the above problems and deficiencies has the following significance: according to the present disclosure, based on the acquisition of a large amount of photosynthetic data of the red-blue light source in the field environment and comparison of the double hyperbolic curve regression model with the other five regression models, it is found that solving the problems and deficiencies of the relatively low fitting accuracy of the five commonly used regression models helps fitting regression of photosynthetic data from red-blue light source in non-field environment, and is suitable for the double hyperbolic curve regression model. In other words, a light environment-carbon sequestration benefit curve for studying the photosynthetic properties of plants has wide applicability.

### SUMMARY OF THE DISCLOSURE

In order to solve the problems in the related art, the present disclosure provides a regression-based plant light environment-carbon sequestration benefit curve (light response curve) determination method, and in particular relates to an analysis method and system based on experimental data of a red-blue light source, a medium, and computer device.

The present disclosure is implemented by a regression-based plant light environment-carbon sequestration benefit curve (light response curve) determination method, and the method includes the following steps:
a first step of performing data regression analysis by using various models, so as to obtain respective regression models and obtaining different fitted model equations through different regression methods;
a second step of verifying data regression equations of the respective models by using a root mean squared error (RMSE) value, so as to verify a fitted value of which one of the regression models is closer to an experimental value; and
a third step of selecting a double hyperbolic curve regression model having a smallest root mean square error (RMSE) value as an optimal one of the models.

Further, in the first step, the model includes the double hyperbolic curve regression model, a rectangular hyperbola model, a single exponential equation, a double exponential model (DEM), a modified rectangular hyperbolic (MRH) model, and a non-rectangular hyperbola (NRH) model.

Further, in the second step, the data regression equations of the respective models are verified based on the root mean squared error (RMSE) value as follows:

$$RMSE = \sqrt{\frac{1}{n} \sum ( yi - y ) {b}^{2}} ;$$

in the formula, yi is an experimental value of a PHOTO net photosynthetic rate, y is a fitted value, n is the number of observations, the closer R² is to 1, the smaller a value of RMSE is, and the higher the goodness-of-fit is.

Further, the regression-based plant light environment-carbon sequestration benefit curve (light response curve) determination method further includes:
(1) measuring a red-blue light source for garden tree species by using a Li6400XT photosynthesis system;
(2) using a double hyperbolic curve to fit photosynthesis data of the red-blue light source, so as to obtain a light environment-carbon sequestration benefit curve through regression; and
(3) based on the fitted light environment-carbon sequestration benefit curve (light response curve), obtaining formulas corresponding to light composition (LCP), a light saturation point (LSP), and an apparent quantum yield (AQY) through regression.

Further, in step (1), the red-blue light source is measured for garden tree species in field environment by using the Li6400XT photosynthesis system, and a light response curve is fitted by using the new double hyperbolic curve regression model so as to construct a photoresponse model.

A red-blue light source experimental test is performed by taking a red-blue light leaf chamber as a light source to simulate natural light, an effect of light intensity on photosynthesis of plants is analyzed for 12 points, red-blue light source data and photosynthesis data of plants are obtained and thus the light environment-carbon sequestration benefit curve (light response curve) affected by the light intensity is obtained.

Further, red light: blue light in the red-blue light leaf chamber is set to 9:1, that is, 9R: 1B.

Further, the light intensity at 11 points is 0 μmol·m⁻²·s⁻¹, 50 μmol·m⁻²·s⁻¹, 80 μmol·m⁻²·s⁻¹, 150 μmol m⁻²·s⁻¹, 200 μmol·m⁻²·s⁻¹, 400 μmol·m⁻²·s⁻¹, 500 μmol m⁻²·s⁻¹, 750 μmol·m⁻²·s⁻¹, 1,000 μmol·m⁻²·s⁻¹, 1,200 μmol·m⁻²·s⁻¹ and 1,500 μmol·m⁻²·s⁻¹ (year 2021).

Further, in step (1), the light environment-carbon sequestration benefit curve (light response curve) of plants is created to obtain a regression equation between a net photosynthetic rate of plants and light intensity, so as to calculate the net photosynthetic rate of plants based on the light intensity, a red-blue light experiment is performed on plants by using the Li6400XT photosynthesis system, and the light environment-carbon sequestration benefit curve is fitted through regression by using a double hyperbolic curve, so as to construct a relationship between the net photosynthetic rate of leaves per unit square meter and the light intensity, and establish a scientific and reasonable relationship between the plant carbon sequestration and analysis of light environment outside a building.

Further, in step (2), the double hyperbolic curve is used to fit the photosynthesis data of the red-blue light source, and the following light environment-carbon sequestration benefit curve is obtained through regression:

$$PHOTO = a \times PAR + \frac{b}{PAR + d} + c$$

in the formula, PHOTO is a fitted net photosynthetic rate, and PAR is photosynthetically active radiation in unit of μmol/m²·s.

Further, in step (3), the formulas corresponding to the light composition (LCP), the light saturation point (LSP) and the apparent quantum yield (AQY) obtained through regression based on the fitted light environment-carbon sequestration benefit curve include:

$$LCP = \frac{\sqrt{{( ad + c )}^{2} - 4 a ( b + cd )} - ( ad + c )}{2 a} \qquad 1 )$$

in which LCP is the light compensation and is a PAR value when the net photosynthetic rate (PHOTO) is zero,

$$LSP = \sqrt{\frac{b}{a}} - d \qquad 2 )$$

in which LSP is the light saturation point and is a PAR value when the net photosynthetic rate is the maximum, and

$$Apparent quantum yield ( AQY ) = a - \frac{b}{{( x + d )}^{2}} \qquad 3 )$$

in which the apparent quantum yield is an initial slope of the curve, that is, the initial slope of the light environment-carbon sequestration benefit curve in a weak light phase, and PAR=0-500 is selected as the slope of the fitted curve in this experiment.

Another object of the present disclosure is to provide computer device, the computer device includes a storage medium and a processor, a computer program is stored in the storage medium, and the processor is configured to execute the computer program to perform the steps in the regression-based plant light environment-carbon sequestration benefit curve (light response curve) determination method.

Another object of the present disclosure is to provide a regression-based plant light environment-carbon sequestration benefit curve (light response curve) determination system for implementing the regression-based plant light environment-carbon sequestration benefit curve (light response curve) determination method, and the system includes:
a data regression analysis module configured to perform data regression analysis by using various models, so as to obtain respective regression models;
a data regression equation verification module configured to verify data regression equations of the respective models based on a root mean squared error (RMSE) value; and
an optimal model selection module configured to select a double hyperbolic curve regression model as an optimal one of the models.

According to all of the above technical solutions, the present disclosure has the following advantages and positive effects: in the regression-based plant light environment-carbon sequestration benefit curve (light response curve) determination method provided by the present disclosure, the red-blue light source data at home and abroad are analyzed by using the new double hyperbolic curve regression model in the present disclosure to fit the light response curve, so as to construct a more accurate light response curve model, thus providing a basis for calculating annual carbon sequestration benefits of plants in the future. At the same time, the technique can also be applied to description of photosynthetic properties of plants in the field environment and to the regression plotting of all plant light response curves.

The present disclosure is implemented by using the double hyperbolic curve to fit parameters of the light environment-carbon sequestration benefit curve (light response curve) model, such as fitting parameters including the light composition (LCP), the light saturation point (LSP) and the apparent quantum yield (AQY). The light environment-carbon sequestration benefit curve (light response curve) model is fitted using the double hyperbolic curve in the present disclosure, and is more accurate than the models fitted by other regression methods, and regression analysis can be performed on the experimental value to obtain the carbon sequestration benefits of plants more accurately.

In the present disclosure, effects and variations of photosynthesis of urban plants in field environment when the light intensity changes in the field environment can be better simulated, more accurate data measurement and analysis method for calculating annual carbon sequestration benefits of plants in the future can be provided.

### DESCRIPTION OF ATTACHED DRAWINGS

In order to illustrate the technical solutions of embodiments in the present disclosure more clearly, the attached drawings needed in examples of the present disclosure are described briefly below. Obviously, the drawings described below are merely some examples of the present disclosure, for those ordinary skilled in the art, other drawings can be obtained according to these drawings without creative efforts.

FIG. 1 is a flow chart of a regression-based plant light environment-carbon sequestration benefit curve (light response curve) determination method according to an embodiment of the present disclosure.

FIG. 2 is a schematic diagram showing a principle of optimizing regression models for a plant light environment-carbon sequestration benefit curve (light response curve) according to the embodiment of the present disclosure.

FIG. 3 is a flow chart showing regression and data analysis of the light environment-carbon sequestration benefit curve (light response curve) according to the embodiment of the present disclosure.

FIG. 4 is a diagram of a light environment-carbon sequestration benefit curve (light response curve) of Lonicera maackii according to the embodiment of the present disclosure.

FIG. 5 is a diagram of a light environment-carbon sequestration benefit curve (light response curve) of Prunus davidiana according to the embodiment of the present disclosure.

FIG. 6 is a diagram of a light environment-carbon sequestration benefit curve (light response curve) of Syringa oblata Lindl. according to the embodiment of the present disclosure.

FIG. 7 is a diagram of a light environment-carbon sequestration benefit curve (light response curve) of Acer truncatum Bunge according to the embodiment of the present disclosure.

FIG. 8 is a diagram of a light environment-carbon sequestration benefit curve (light response curve) of Prunus persica ‘Duplex’ according to the embodiment of the present disclosure.

FIG. 9 is a diagram of a light environment-carbon sequestration benefit curve (light response curve) of Ulmus pumila L. according to the embodiment of the present disclosure;

FIG. 10 is a diagram of a light environment-carbon sequestration benefit curve (light response curve) of Tilia tuan Szyszyl. according to the embodiment of the present disclosure.

FIG. 11 is a diagram of a light environment-carbon sequestration benefit curve (light response curve) of Sorbaria sorbifolia according to the embodiment of the present disclosure.

FIG. 12 is a diagram of a light environment-carbon sequestration benefit curve (light response curve) of Syringa reticulata according to the embodiment of the present disclosure.

FIG. 13 is a diagram of a light environment-carbon sequestration benefit curve (light response curve) of Koelreuteria paniculata Laxm. according to the embodiment of the present disclosure.

FIG. 14 is a diagram of a light environment-carbon sequestration benefit curve (light response curve) of Prunus sibirica L. according to the embodiment of the present disclosure.

FIG. 15 is a diagram of a light environment-carbon sequestration benefit curve (light response curve) of Styphnolobium japonicum according to the embodiment of the present disclosure.

FIG. 16 is a diagram of a light environment-carbon sequestration benefit curve (light response curve) of Platanus occidentalis L. according to the embodiment of the present disclosure.

FIG. 17 is a flow chart of a method for calculating plant photosynthesis according to the embodiment of the present disclosure.

FIG. 18 is a flow chart of a method for fitting a leaf area of a single plant according to the embodiment of the present disclosure.

FIG. 19 is a flow chart of a method for calculating carbon sequestration of a single plant according to the embodiment of the present disclosure.

### SPECIFIC EMBODIMENTS

In order to make objects, technical solutions and advantages clearer, the present disclosure is further described in detail below with reference to embodiments. It should be understood that the specific embodiments described herein are merely illustrative of the present disclosure and should not be deemed as limiting the scope of the present disclosure.

Regarding the problems in the related art, the present disclosure provides a regression-based plant light environment-carbon sequestration benefit curve (light response curve) determination method and system, and a medium. The present disclosure will be described in detail with reference to the accompanying drawings.

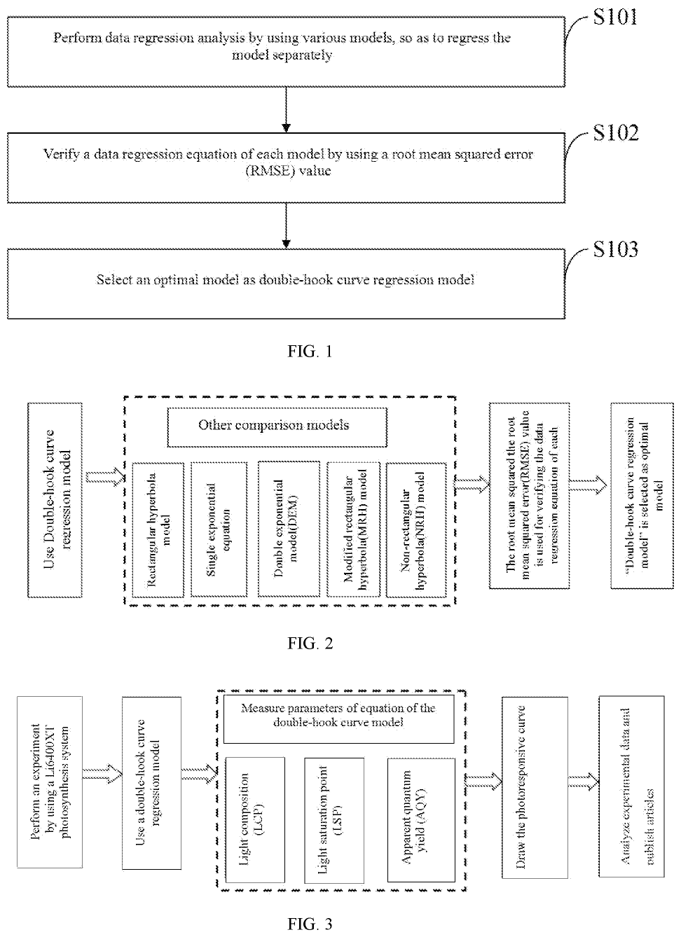

As shown in FIG. 1, a regression-based plant light environment-carbon sequestration benefit curve (light response curve) determination method according to an embodiment of the present disclosure includes the following steps:

S101, performing data regression analysis by using various models, so as to obtain respective regression models;

S102, verifying data regression equations of the respective models based on a root mean squared error (RMSE) value; and

S103, selecting a double hyperbolic curve regression model as an optimal one of the models.

The technical solutions of the present disclosure are described further with reference to the specific embodiments.

### First Embodiment

Referring to FIG. 2, a double hyperbolic curve regression model, a rectangular hyperbola model, a single exponential equation, a double exponential model (DEM), a modified rectangular hyperbolic (MRH) model, and a non-rectangular hyperbola (NRH) model are adopted to perform data regression analysis so as to obtain regression models.

Referring to FIG. 2, data regression equations of the above models including the double hyperbolic curve regression model, the rectangular hyperbola model, the single exponential equation, the double exponential model (DEM), the modified rectangular hyperbolic (MRH) model and the non-rectangular hyperbola (NRH) model are verified based on a root mean squared error (RMSE) value:

$$RMSE = \sqrt{\frac{1}{n} \sum ( yi - y ) {b}^{2}}$$

in the formula, yi is an experimental value of a PHOTO net photosynthetic rate, y is a fitted value, n is the number of observations, the closer R² is to 1, the smaller a value of RMSE is, and the higher the goodness-of-fit is.

The RMSE value in a case of the double hyperbolic curve regression model used in the present disclosure is 0.38. It is thus proved that the method of performing fitting regression analysis by using the new double hyperbolic curve model in the present disclosure is better, and the experimental value is fitted more accurately as compared with those using the above regression methods.

### SECOND EMBODIMENT

According to the present disclosure, a red-blue light source for major garden tree species in an area of Beijing in field environment is measured by using a Li6400XT photosynthesis system. In analysis of red-blue light source data at home and abroad, a new double hyperbolic curve regression model is first employed in the present disclosure to fit a light response curve, so as to construct a more accurate light response curve model, thus providing a basis for calculating annual carbon sequestration benefits of plants in the future.

According to the present disclosure, a red-blue light source experimental test is performed by taking a red-blue light leaf chamber (red light: blue light=9:1, 9R: 1B) as a light source to simulate natural light, and an effect of light intensity on photosynthesis of plants is studied for 12 points so as to obtain photosynthesis data. The double hyperbolic curve first used in the present disclosure to fit the photosynthesis data of the red-blue light source is as follows:

$$PHOTO = a \times PAR + \frac{b}{PAR + d} + c$$

in the formula, PHOTO is a fitted net photosynthetic rate, and PAR is photosynthetically active radiation (μmol/m²·s).

According to the present disclosure, the light environment-carbon sequestration benefit curve (light response curve) of plants is created to obtain a regression equation between a net photosynthetic rate of plants and light intensity, so as to calculate the net photosynthetic rate of plants based on the light intensity. A red-blue light experiment is performed on common plants in high-density residential areas in Beijing by using the Li6400XT photosynthesis system, and regression is performed on the light environment-carbon sequestration benefit curve through a more reasonable regression method by using a double hyperbolic curve, so as to construct a relationship between the net photosynthetic rate of leaves per unit square meter and the light intensity, and establish a scientific and reasonable relationship between the plant carbon sequestration and analysis of light environment outside a building, thus providing a solid theoretical foundation for simulating plant carbon sequestration in urban built-up areas by using a computer.

According to the present disclosure, a red-blue light source experimental test is performed by taking the red-blue light leaf chamber (red light: blue light=9:1, 9R: 1B) as the light source to simulate the natural light and the effect of the light intensity on the photosynthesis of plants is analyzed for 11 points, so as to obtain photosynthesis data. The light intensity at 11 points is 0 μmol·m⁻²·s⁻¹,50 μmol·m⁻²·s⁻¹,80 μmol m⁻²·s⁻¹, 150 μmol·m⁻²·s⁻¹,200 μmol·m⁻²·s⁻¹,400 μmol·m⁻²·s⁻¹,500 μmol·m⁻²·s⁻¹,750 μmol·m⁻²·s⁻¹, 1,000 μmol·m⁻²·s⁻¹, 1,200 μmol. m⁻²·s⁻¹ and 1,500 μmol·m⁻²·s⁻¹. Red-blue light source data of more than 90 species of plants, including Koelreuteria paniculata Laxm., Morus mongolica, Prunus davidiana and Ginkgo biloba L. is obtained, so as to obtain the light environment-carbon sequestration benefit curves (light response curves) influenced by the light intensity. A new regression fitting formula is used in addition to the five commonly used formulas, and a better fitting effect between the light intensity PAR and the net photosynthetic curve is obtained.

According to the present disclosure, effects and variations of photosynthesis of urban plants in a field environment can be better simulated when the light intensity changes in the field environment.

According to the present disclosure, the double hyperbolic curve is first used to fit the photosynthesis data of the red-blue light source, and the following light environment-carbon sequestration benefit curve (light response curve) is obtained through regression:

$$PHOTO = a \times PAR + \frac{b}{PAR + d} + c$$

in the formula, PHOTO is a fitted net photosynthetic rate, and PAR is photosynthetically active radiation (μmol/m²·s).

The formulas corresponding to light composition (LCP), a light saturation point (LSP), and an apparent quantum yield (AQY) are obtained by regression based on the fitted curve, thus providing a theoretical basis for more accurately fitting the light environment-carbon sequestration benefit curve (light response curve).

$$LCP = \frac{\sqrt{{( ad + c )}^{2} - 4 a ( b + cd )} - ( ad + c )}{2 a} \qquad ( 1 )$$

LCP is the light compensation and is a PAR value when the net photosynthetic rate (PHOTO) is zero, and is denoted as LCP (the same applies hereinafter),

$$LSP = \sqrt{\frac{b}{a}} - d \qquad ( 2 )$$

LSP is the light saturation point and is a PAR value when the net photosynthetic rate is the maximum, that is, photo=max, and is denoted as LSP (the same applies hereinafter), and

$$AQY = a - \frac{b}{{( x + d )}^{2}} \qquad ( 3 )$$

the apparent quantum yield is an initial slope of the curve, that is, the initial slope of the light environment-carbon sequestration benefit curve (light response curve) in a weak light phase, for this experiment, a slope of the fitted curve in a range PAR=0 to the light compensation point is selected, and the apparent quantum yield is denoted as AQY.

TABLE 2
Light compensation (LCP), light saturation point (LSP) and apparent
quantum yield of each of garden tree species in area of Beijing

| | Light | Light | apparent |
|---|---|---|---|
| | composition | saturation | quantum |
| Name | (LCP) | point (LSP) | yield (AQY) |
| Lonicera aackii | 14.31394 | 1063.851 | 0.0746 |
| Prunus avidiana | 33.27757 | 765.4328 | 0.071985 |
| Syringa oblata Lindl. | 21.26806 | 972.1709 | 0.05104 |
| Acer truncatum Bunge | 27.97418 | 808.9203 | 0.067069 |
| Prunus persica ‘Duplex’ | 9.251796 | 1024.752 | 0.064539 |
| Ulmus pumila L. | 13.84171 | 1226.78 | 0.058816 |
| Tilia tuan Szyszyl. | 39.51724 | 1846.165 | 0.021636 |
| Sorbaria sorbifolia | 40.5415 | 1050.565 | 0.057883 |
| Syringa reticulata | 45.39283 | 886.6127 | 0.05532 |
| Koelreuteria paniculata Laxm. | 21.75749 | 847.2752 | 0.071679 |
| Prunus sibirica L. | 36.80242 | 1614.592 | 0.061972 |
| Styphnolobium japonicum | 24.63926 | 1225.788 | 0.065617 |
| Platanus occidentalis L. | 17.95337 | 1005.548 | 0.08577 |

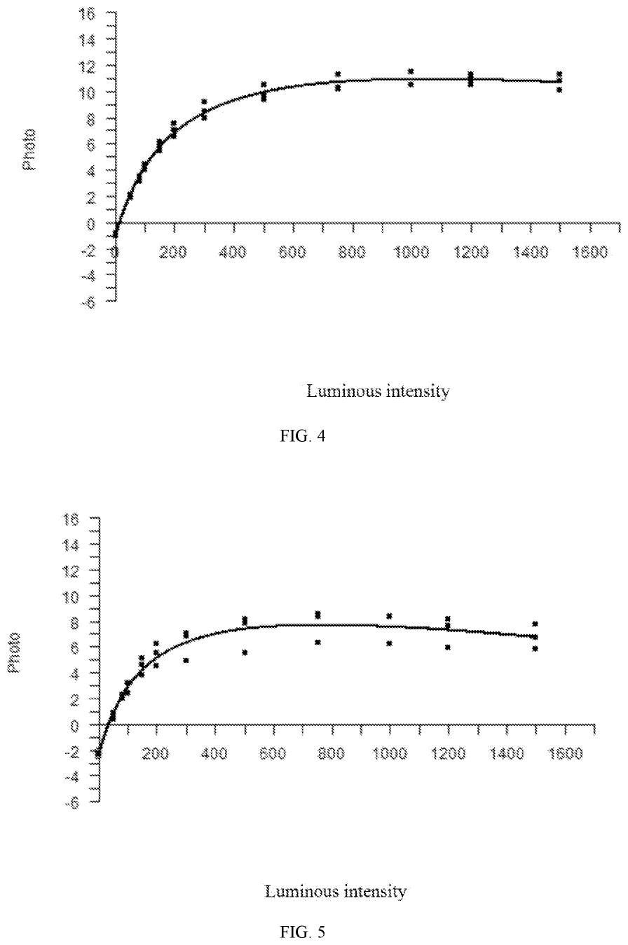

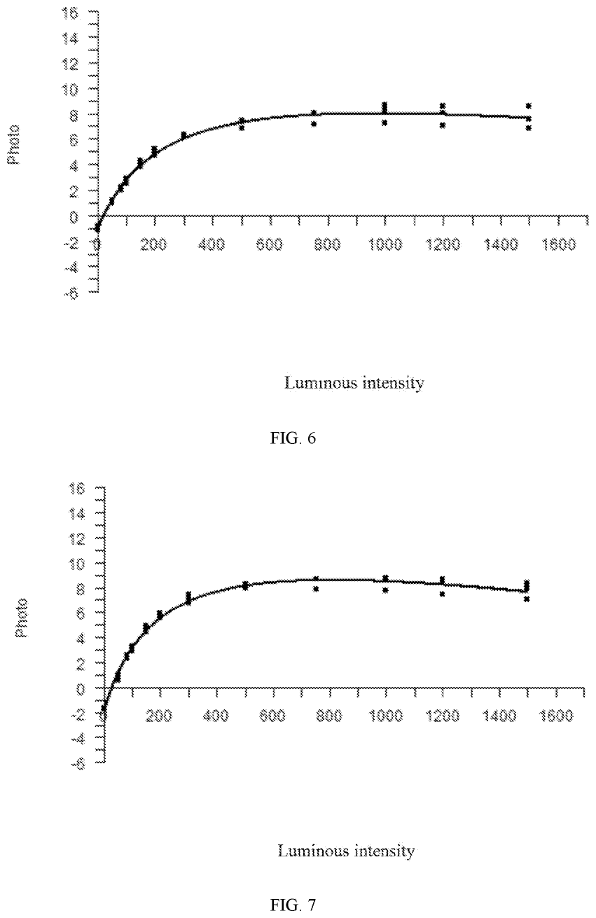

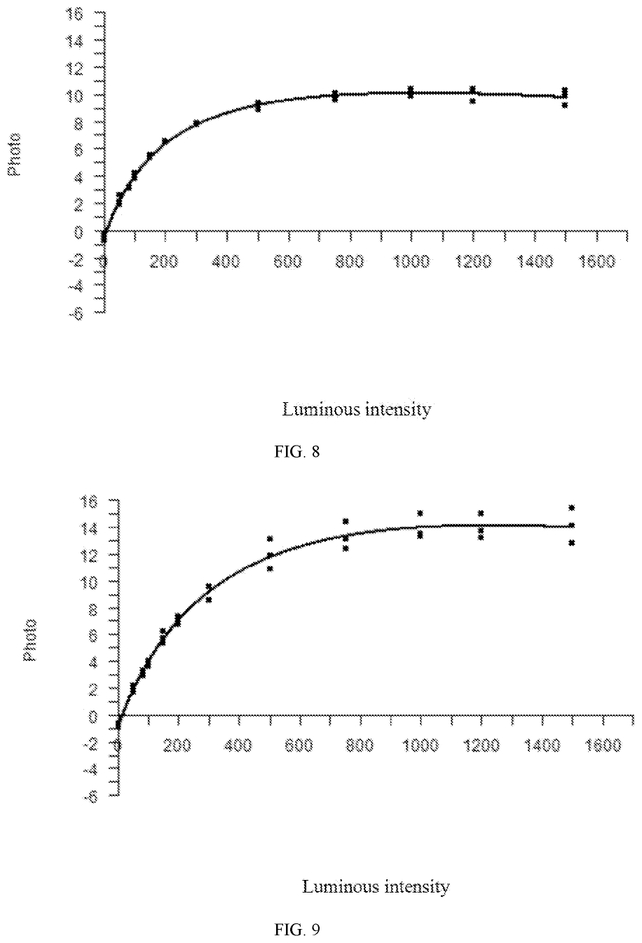

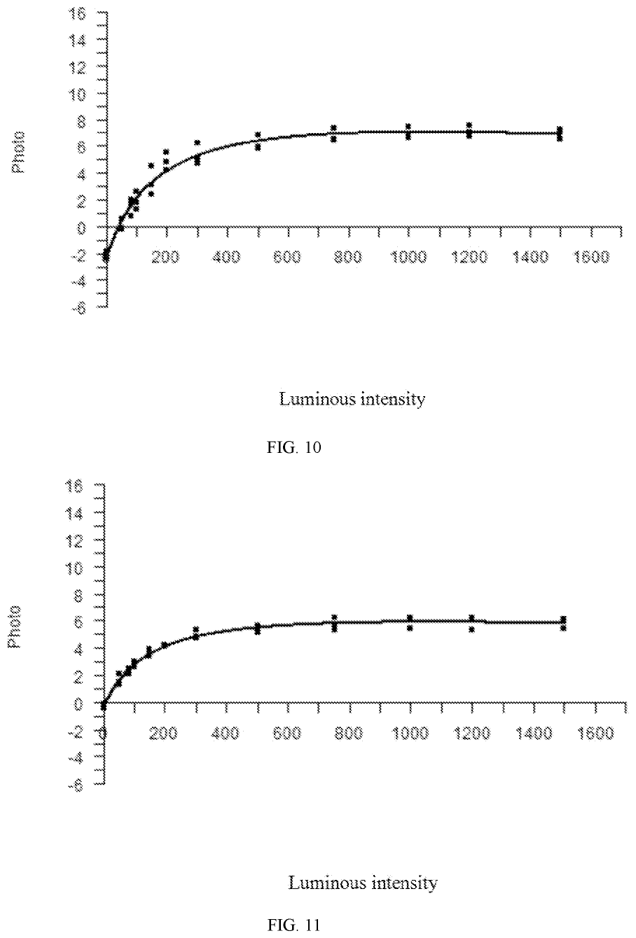

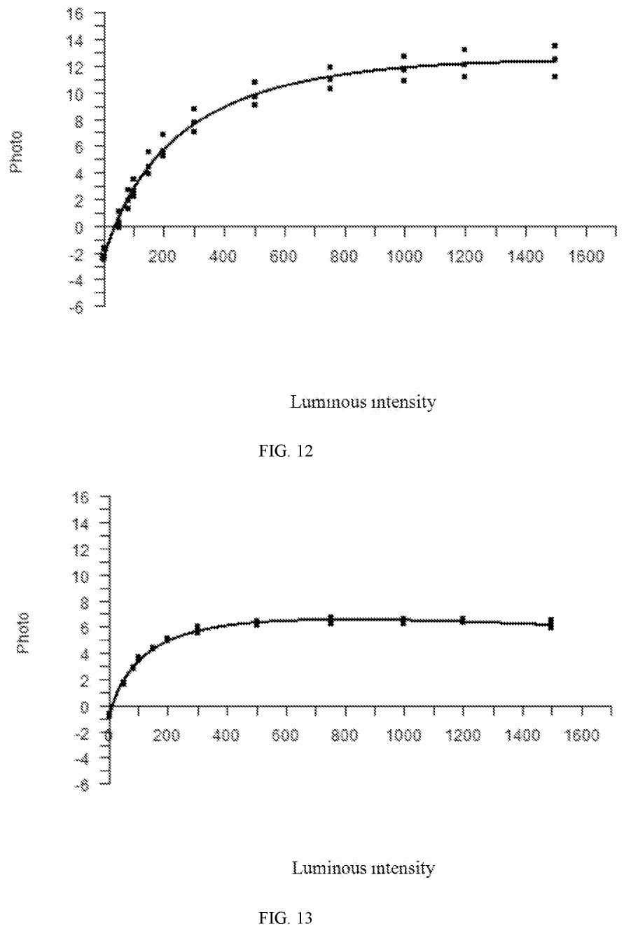

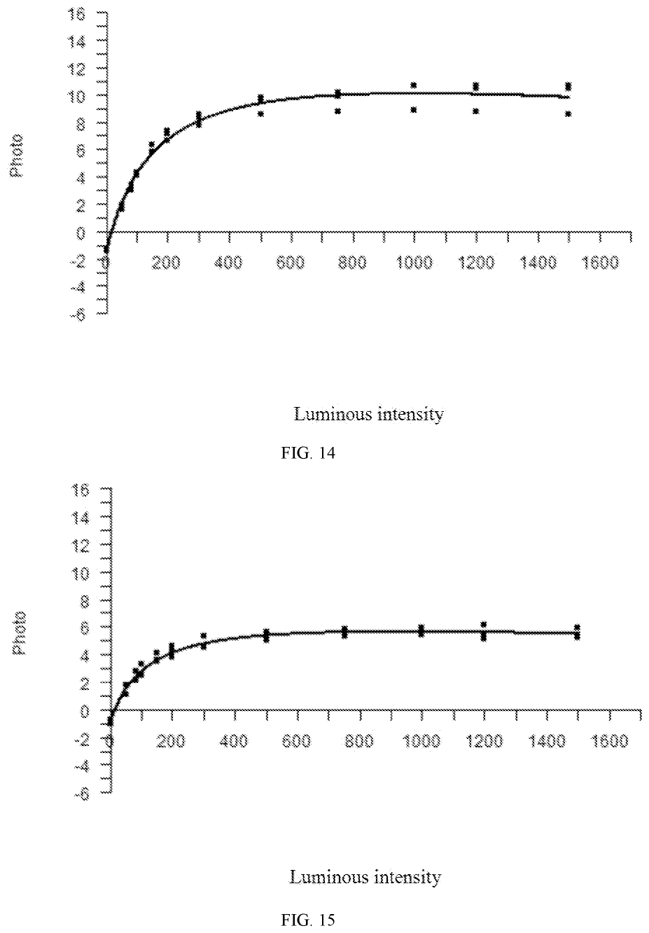

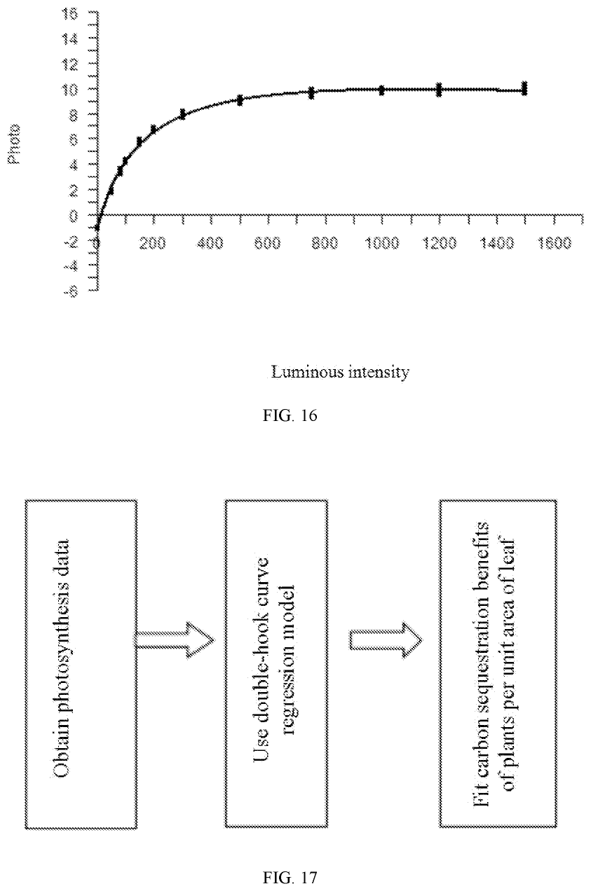

A light environment-carbon sequestration benefit curve (light response curve) of the Lonicera maackii is shown in FIG. 4, a light environment-carbon sequestration benefit curve (light response curve) of the Prunus davidiana is shown in FIG. 5, a light environment-carbon sequestration benefit curve (light response curve) of the Syringa oblata Lindl. is shown in FIG. 6, a light environment-carbon sequestration benefit curve (light response curve) of the Acer truncatum Bunge is shown in FIG. 7, a light environment-carbon sequestration benefit curve (light response curve) of the Prunus persica ‘Duplex’ is shown in FIG. 8, a light environment-carbon sequestration benefit curve (light response curve) of the Ulmus pumila L. is shown in FIG. 9, a light environment-carbon sequestration benefit curve (light response curve) of the Tilia tuan Szyszyl. is shown in FIG. 10, a light environment-carbon sequestration benefit curve (light response curve) of the Sorbaria sorbifolia is shown in FIG. 11, a light environment-carbon sequestration benefit curve (light response curve) of the Syringa reticulata shown in FIG. 12, a light environment-carbon sequestration benefit curve (light response curve) of the Koelreuteria paniculata Laxm. is shown in FIG. 13, a light environment-carbon sequestration benefit curve (light response curve) of the Prunus sibirica L. is shown in FIG. 14, a light environment-carbon sequestration benefit curve (light response curve) of the Styphnolobium japonicum is shown in FIG. 15, and a light environment-carbon sequestration benefit curve (light response curve) of the Platanus occidentalis L. is shown in FIG. 16.

### Third Embodiment

A new light environment-carbon sequestration benefit curve (light response curve) simulation method is adopted in the embodiment of the present disclosure, which can be widely used in photosynthetic experiments of plants.

Referring to FIG. 3, according to regression curve simulation, it is possible to more accurately reflect a relationship between carbon sequestration benefits of plant photosynthesis and light intensity, to reflect photosynthetic properties of plants, and to fit the carbon sequestration benefits of photosynthesis. This method can be applied to the plotting of the light environment-carbon sequestration benefit curve (photoresponse curve), and physiological properties of plants can be better reflected.

A project team performs tests on light response curves of 14 common garden plants in the area of Beijing, and compares model methods including a double hyperbolic curve fitting model (NLS), a rectangular hyperbola (RH) model, a non-rectangular hyperbola (NRH) model, a single exponential regression model (SEM), a double exponential model (DEM), and a modified rectangular hyperbolic (MRH) model, and a RMSE value is used for verifying. It is found that, in the above garden plants, the RMSE value in a case of the double hyperbolic curve fitting model (NLS) is the lowest as compared with those in the case of the other five common models, and it is indicated that fitting accuracy of the double hyperbolic curve fitting model (NLS) is the highest in fitting an experimental value among the six models and has the best fitting effect.

TABLE 3
Comparison of RMSE values calculated by six regression
equations for common garden plants in area of Beijing

| | double | | | | | |
|---|---|---|---|---|---|---|
| | hyperbolic | | | | | |
| | curve | | Non-rectangular | Single | Double | Modified |
| | fitting | Rectangular | hyperbola | exponential | exponential | rectangular |
| | model | hyperbola | model | regression | model | hyperbolic |
| Name | (NLS) | model (RH) | (NRH) | model (SEM) | (DEM) | model (MRH) |
| Lonicera | 0.38 | 0.80 | 0.57 | 0.60 | 0.48 | 0.48 |
| maackii | | | | | | |
| Prunus | 0.77 | 1.21 | 1.13 | 1.26 | 1.08 | 0.90 |
| davidiana | | | | | | |
| Syringa oblata | 0.39 | 0.71 | 0.58 | 0.64 | 0.51 | 0.49 |
| Lindl. | | | | | | |
| Acer | 0.36 | 1.00 | 0.85 | 0.77 | 0.71 | 0.60 |
| truncatum | | | | | | |
| Bunge | | | | | | |
| Prunus persica | 0.25 | 0.70 | 0.43 | 0.38 | 0.31 | 0.39 |
| ‘Duplex’ | | | | | | |
| Ulmus pumila | 0.61 | 1.10 | 0.76 | 0.81 | 0.66 | 0.71 |
| L. | | | | | | |
| Tilia tuan | 0.55 | 1.08 | 0.97 | 0.95 | 0.93 | 0.59 |
| Szyszyl. | | | | | | |
| Sorbaria | 0.28 | 0.37 | 0.31 | 0.40 | 0.32 | 0.31 |
| sorbifolia | | | | | | |
| Syringa | 0.69 | 1.31 | 1.08 | 1.08 | 1.02 | 0.71 |
| reticulata | | | | | | |
| Koelreuteria | 0.18 | 0.46 | 0.36 | 0.35 | 0.28 | 0.31 |
| paniculata | | | | | | |
| Laxm. | | | | | | |
| Prunus sibirica | 0.57 | 0.9 | 0.77 | 0.83 | 0.72 | 0.64 |
| L. | | | | | | |
| Styphnolobium | 0.31 | 0.47 | 0.42 | 0.53 | 0.42 | 0.35 |
| japonicum | | | | | | |
| Platanus | 0.24 | 0.70 | 0.47 | 0.49 | 0.41 | 0.33 |
| occidentalis L. | | | | | | |

### Fourth Embodiment

Referring to FIG. 17, a double hyperbolic curve regression model can be used for calculating plant photosynthesis under a simulated light intensity condition and subsequently for simulating and calculating carbon sequestration benefits of plants per unit leaf area.

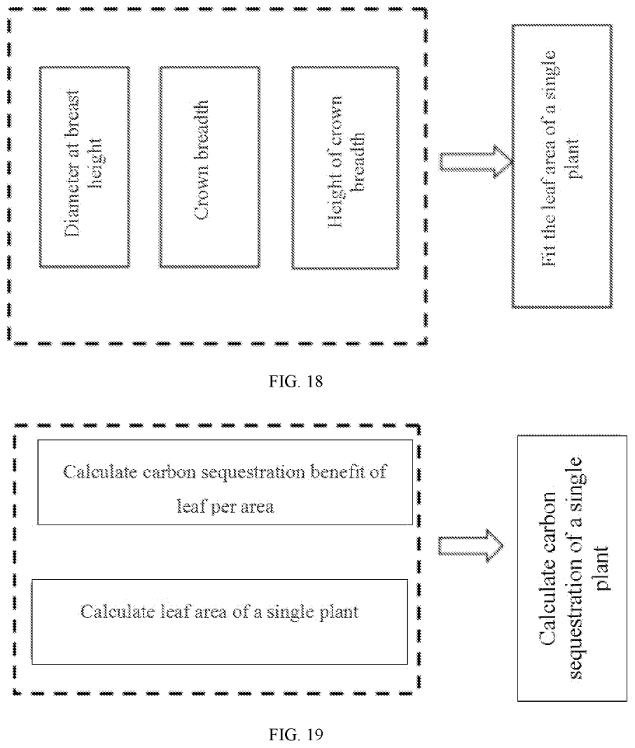

Referring to FIG. 18, a leaf area of a single plant is fitted based on data of the plant including a diameter at a breast height, a crown spread, and a height of a crown base, so as to obtain a regression formula.

Referring to FIG. 19, the carbon sequestration of the single plant is calculated based on calculation of carbon sequestration benefits per unit leaf area and calculation of the leaf area of the single plant.

It can be seen that the double hyperbolic curve regression model can be well applied in the regression of a light environment-carbon sequestration benefit curve (light response curve), and a more accurate simulation model can be provided for calculating the carbon sequestration of plants. The present disclosure is implemented by using the double hyperbolic curve to fit parameters such as a light composition (LCP), a light saturation point (LSP) and an apparent quantum yield (AQY) of the light environment-carbon sequestration benefit curve (light response curve) model. According to the present disclosure, the light environment-carbon sequestration benefit curve (light response curve) model fitted by the double hyperbolic curve is more accurate than models fitted by other regression methods, so that the carbon sequestration benefits of plants can be regressed more accurately by using an experimental value.

According to the present disclosure, effects and variations of photosynthesis of urban plants in field environment when light intensity changes can be better simulated, thus providing a more accurate data measurement and analysis method for calculating annual carbon sequestration benefits of plants in the future.

The above embodiments can be carried out entirely or partially in a form of software, hardware, firmware or a combination of software, hardware and firmware. When the above embodiments are carried out entirely or partially in a form of a computer program product, the computer program product includes one or more computer instructions. When the computer program instructions are loaded or executed in a computer, the computer operates entirely or partially according to a process or function of the embodiments of the present disclosure. The computer can be a general-purpose computer, a special-purpose computer, a computer network or other programmable devices. The computer instructions can be stored in a computer-readable storage medium or transmitted from one computer-readable storage medium to another. For example, the computer instructions may be transmitted from a website, a computer, a server, or a data center to another website, computer, server, or data center via a wired (e.g, coaxial cable, optical fiber, digital subscriber line (DSL), or wireless (e.g, infrared, wireless, microwave, etc.) manner. The computer-readable storage medium may be any available medium that the computer can access or a data storage device such as a server, or data center that includes one or more available media integrated. The available medium may be a magnetic medium (e.g., floppy disk, hard disk, magnetic tape), optical media (e.g., DVD), or semiconductor media (e.g., Solid State Disk (SSD).

The above-mentioned are only the embodiments of the present disclosure, but a protection scope of the present disclosure is not limited thereto. Within the technical scope disclosed by the present disclosure, modifications, equivalent replacements or improvements which are made by those skilled in the art and are made within the spirit and scope of the present disclosure, should fall within the scope of protection of the present disclosure.

1. A regression-based plant light environment-carbon sequestration benefit curve determination method comprising the following steps:
a first step of performing data regression analysis by using various models, so as to obtain respective regression models;
a second step of verifying data regression equations of the respective models based on a root mean squared error (RMSE) value; and
a third step of selecting a double hyperbolic curve regression model as an optimal one of the models.

2. The regression-based plant light environment-carbon sequestration benefit curve determination method according to claim 1, wherein
in the first step, the models include the double hyperbolic curve regression model, a rectangular hyperbola model, a single exponential equation, a double exponential model (DEM), a modified rectangular hyperbolic (MRH) model, and a non-rectangular hyperbola (NRH) model.

3. The regression-based plant light environment-carbon sequestration benefit curve determination method according to claim 1, wherein
in the second step, the data regression equations of the respective models are verified based on the root mean squared error (RMSE) value as follows:
$$RMSE = \sqrt{\frac{1}{n} \sum ( yi - y ) {b}^{2}}$$
in the formula, yi is an experimental value of a PHOTO net photosynthetic rate, y is a fitted value, n is the number of observations, the closer b2 is to 1, the smaller a value of RMSE is, and the higher the goodness-of-fit is.

4. The regression-based plant light environment-carbon sequestration benefit curve determination method according to claim 1 further comprising:
(1) measuring a red-blue light source for garden tree species by using a Li6400XT photosynthesis system;
(2) using a double hyperbolic curve to fit photosynthesis data of the red-blue light source, so as to obtain a light environment-carbon sequestration benefit curve through regression; and
(3) based on the fitted light environment-carbon sequestration benefit curve, obtaining formulas corresponding to light composition (LCP), a light saturation point (LSP), and an apparent quantum yield (AQY) through regression.

5. The regression-based plant light environment-carbon sequestration benefit curve determination method according to claim 4, wherein
in step (1), the red-blue light source is measured for garden tree species in field environment by using the Li6400XT photosynthesis system, and a light response curve is fitted by using the new double hyperbolic curve regression model so as to construct a photoresponse model,
a red-blue light source experimental test is performed by taking a red-blue light leaf chamber as a light source to simulate natural light, an effect of light intensity on photosynthesis of plants is analyzed for 11 points, a buffer bottle measurement is additionally performed to obtain red-blue light source data and photosynthesis data of plants in field environment, and thus to obtain the light environment-carbon sequestration benefit curve affected by the light intensity,
red light: blue light of the red-blue light leaf chamber is 9:1, that is, a ratio of the red light to the blue light is set to 9:1 and 9R: 1B is set in the photosynthesis system, so as to simulate the natural light,
the light intensity at 11 points is 0 μmol·m⁻²·s⁻¹,50 μmol·m⁻²·s⁻¹,80 μmol·m⁻²·s⁻¹,150 μmol·m⁻²·s⁻¹,200 μmol·m⁻²·s⁻¹,400 μmol·m⁻²·s⁻¹,500 μmol·m⁻²·s⁻¹,750 μmol·m⁻²·s⁻¹,1,000 μmol·m⁻²·s⁻¹,1,200 μmol·m⁻²·s⁻¹ and 1,500 μmol·m⁻²·s⁻¹ (year 2021), and
CO₂ environment is that in the field environment, interference to measurement of CO₂ concentration is avoided by setting a buffer bottle, so as to simulate variation in photosynthesis and carbon sequestration benefits of plants to light environment in the field environment to the greatest extent.

6. The regression-based plant light environment-carbon sequestration benefit curve determination method according to claim 4, wherein
in step (1), the light environment-carbon sequestration benefit curve of plants is created to obtain a regression equation between a net photosynthetic rate of plants and light intensity, so as to calculate the net photosynthetic rate of plants based on the light intensity, a red-blue light experiment is performed on plants by using the Li6400XT photosynthesis system, and the light environment-carbon sequestration benefit curve is fitted through regression by using a double hyperbolic curve, so as to construct a relationship between the net photosynthetic rate of leaves per unit square meter and PAR, and establish a scientific and reasonable relationship between the plant carbon sequestration and analysis of light environment outside a building, and
in step (2), the double hyperbolic curve is used to fit the photosynthesis data of the red-blue light source, and the following light environment-carbon sequestration benefit curve is obtained through regression:
$$PHOTO = a \times PAR + \frac{b}{PAR + d} + c$$
in the formula, PHOTO is a fitted net photosynthetic rate, and PAR is photosynthetically active radiation in unit of μmol/m²·s.

7. The regression-based plant light environment-carbon sequestration benefit curve determination method according to claim 4, wherein
in step (3), the formulas corresponding to the light composition (LCP), the light saturation point (LSP) and the apparent quantum yield (AQY) obtained through regression based on the fitted light environment-carbon sequestration benefit curve include:
$$LCP = \frac{\sqrt{{( ad + c )}^{2} - 4 a ( b + cd )} - ( ad + c )}{2 a} \qquad 1 )$$
in which LCP is the light compensation and is a PAR value when the net photosynthetic rate (PHOTO) is zero,
$$LSP = \sqrt{\frac{b}{a}} - d \qquad 2 )$$
in which LSP is the light saturation point and is a PAR value when the net photosynthetic rate is the maximum, and
$$Apparent quantum yield ( AQY ) = a - \frac{b}{{( x + d )}^{2}} \qquad 3 )$$
in which the apparent quantum yield is an initial slope of the curve, that is, the initial slope of the light environment-carbon sequestration benefit curve in a weak light phase, and PAR=0-500 is selected as the slope of the fitted curve in this experiment.

8. A computer device comprising:
a storage; and
a processor, wherein
a computer program is stored in the storage, and
the processor executes the computer program to perform the steps in the regression-based plant light environment-carbon sequestration benefit curve determination method according to claim 1.

9. A regression-based plant light environment-carbon sequestration benefit curve determination system for implementing the regression-based plant light environment-carbon sequestration benefit curve determination method according to claim 1, the system comprising:
a data regression analysis module configured to perform data regression analysis by using various models, so as to obtain respective regression models;
a data regression equation verification module configured to verify data regression equations of the respective models based on a root mean squared error (RMSE) value; and
an optimal model selection module configured to select a double hyperbolic curve regression model as an optimal one of the models.
